(19) United States
(12) Patent Application Publication
(10) Pub. No.: US 2014/0132510 A1
(43) Pub. Date: May 15, 2014

(54) Handheld Electronic Apparatus, Operating Method Thereof, and Non-Transitory Computer Readable Medium Thereof

(71) Applicant: PIXART IMAGING INC., Hsin-Chu (TW)

(72) Inventor: Yen-Min Chang, Hsin-Chu (TW)

(73) Assignee: PixArt Imaging Inc., Hsin-Chu (TW)

(21) Appl. No.: 13/863,435

(22) Filed: Apr. 16, 2013

(30) Foreign Application Priority Data
Nov. 14, 2012 (TW) 101142318

(51) Int. Cl. G06F 3/0354

(52) U.S. Cl. CPC G06F 3/0354
USPC 345/158

(57) ABSTRACT

A handheld electronic apparatus, an operating method thereof, and a non-transitory computer readable medium thereof are provided. The handheld electronic apparatus includes a sensor, a processing unit, and an interface. When the handheld electronic apparatus is moved from a first position to a second position, the sensor generates a plurality of sensed data. The processing unit calculates a movement direction and a movement distance according to the sensed data. The interface is connected to a computer having a monitor. The interface transmits a control signal to the computer. The control signal carries the movement direction and a movement distance so that the computer controls a cursor shown on the monitor to move from a first coordinate to a second coordinate according to the movement direction and a movement distance carried in the control signal.

This application claims priority to Taiwan Patent Application No. 101142318 filed on Nov. 14, 2012.

### CROSS-REFERENCES TO RELATED APPLICATIONS

Not applicable.

### BACKGROUND OF THE INVENTION

1. Field of the Invention

The present invention relates to a handheld electronic apparatus, an operating method thereof, and a non-transitory computer readable medium thereof. More particularly, the present invention relates to a handheld electronic apparatus capable of controlling a cursor of a monitor, an operating method thereof, and a non-transitory computer readable medium thereof.

2. Descriptions of the Related Art

Computer mice are used as primary input devices for conventional computer peripheral devices. Users often use the computer mouse to move a cursor shown on a monitor, or even use the mouse to select the desired options, applications, etc. Therefore, computer mice have become an important bridge for communication between users and computers. However, because the computer mouse has a volume that occupies a certain space, it is not very portable.

Over recent years, due to the rapid development of the mobile technologies, almost all users will carry handheld electronic apparatuses along when traveling. Therefore, some technologies currently available use handheld electronic apparatuses to simulate computer mice. According to these technologies, different blocks (e.g., a movement region, a left key region, a right key region and a click region) are defined on the touch screen of a handheld electronic apparatus. A user must move a finger and operate in these regions to use the handheld electronic apparatus as a computer mouse. However, moving the finger on the touch screen is different from the user's habits of operating the mouse, making it difficult to use.

Accordingly, it is important to provide a handheld electronic apparatus that allows a user to easily simulate a computer mouse.

### SUMMARY OF THE INVENTION

An objective of the present invention is to provide a handheld electronic apparatus, an operating method thereof, and a non-transitory computer readable medium thereof, which allow a user to control a cursor shown on a monitor of a computer by means of the portable handheld electronic apparatus.

To achieve the aforesaid objective, the present invention provides a handheld electronic apparatus, which comprises a sensor, a processing unit and an interface. The processing unit is electrically connected to the sensor and the interface. The sensor is configured to generate a plurality of sensed data while the handheld electronic apparatus is moved from a first position to a second position. The processing unit is configured to calculate a movement direction and a movement distance according to the sensed data. The interface is adapted to be connected to a computer having a monitor and configured to transmit a control signal carrying the movement direction and the movement distance to the computer so that the computer controls a cursor shown on the monitor to move from a first coordinate to a second coordinate according to the movement direction and the movement distance carried in the control signal.

To achieve the aforesaid objective, the present invention provides an operating method of a handheld electronic apparatus for controlling a cursor shown on a monitor. The monitor is comprised in a computer. The operating method is executed by the handheld electronic apparatus and comprises the following steps: (a) generating a plurality of sensed data while the handheld electronic apparatus is moved from a first position to a second position; (b) calculating a movement direction and a movement distance according to the sensed data; and (c) transmitting a control signal carrying the movement direction and the movement distance to the computer so that the computer controls the cursor shown on the monitor to move from a first coordinate to a second coordinate according to the movement direction and the movement distance.

To achieve the aforesaid objective, the present invention provides a non-transitory computer readable medium, which has a computer program stored therein. The computer program executes an operating method after being loaded into a handheld electronic apparatus so that the handheld electronic apparatus controls a cursor shown on a monitor. The monitor is comprised in a computer. The computer program comprises a code A, a code B and a code C. The code A enables the handheld electronic apparatus to generate a plurality of sensed data while the handheld electronic apparatus is moved from a first position to a second position. The code B enables the handheld electronic apparatus to calculate a movement direction and a movement distance according to the sensed data. The code C enables the handheld electronic apparatus to transmit a control signal carrying the movement direction and a movement distance to the computer so that the computer controls the cursor shown on the monitor to move from a first coordinate to a second coordinate according to the movement direction and a movement distance.

The present invention determines a movement direction and a movement distance according to the sensed data generated by the sensor(s) of the handheld electronic apparatus so that the computer can control a position of the cursor shown on the monitor according to the movement direction and movement distance. Through the present invention, the user can easily operate the cursor shown on the monitor of the computer by means of the portable handheld electronic apparatus.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a schematic view depicting a handheld electronic apparatus 1 according to a first to a fourth embodiment;

FIG. 2 is a schematic view depicting a handheld electronic apparatus 2 according to a fifth embodiment; and

FIG. 3 is a flowchart diagram of an operating method according to a sixth embodiment.

### DESCRIPTION OF THE PREFERRED EMBODIMENT

In the following descriptions, a handheld electronic apparatus, an operating method thereof and a non-transitory computer readable medium thereof of the present invention will be explained with reference to embodiments thereof. However, these embodiments are not intended to limit the present invention to any environments, applications or implementations described in these embodiments. Therefore, the description of these embodiments is only for purpose of illustration rather than to limit the present invention. It shall be appreciated that in the following embodiments and attached drawings, elements not directly related to the present invention are omitted from depiction.

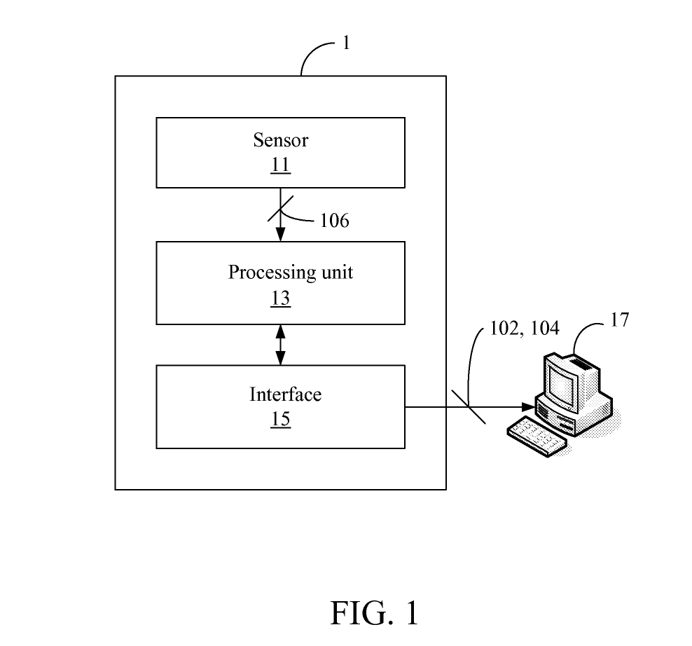

A first embodiment of the present invention is a handheld electronic apparatus 1, a schematic view of which is shown in FIG. 1. The handheld electronic apparatus 1 comprises a sensor 11, a processing unit 13, and an interface 15, wherein the processing unit 13 is electrically connected to the sensor 11 and the interface 15. Furthermore, the handheld electronic apparatus 1 is connected to a computer 17 via the interface 15.

The sensor 11 may be an optical lens, a G-sensor, or other sensors capable of detecting variations of surroundings of the handheld electronic apparatus 1. The processing unit 13 may be any of various processors, central processing units (CPUs), microprocessors, or other computing units well known to those of ordinary skill in the art. The interface 15 may be a Bluetooth transmission interface, an infrared transmission interface, a Universal Serial Bus (USB) interface, a Wireless Fidelity (Wi-Fi) transmission interface, or some other wired or wireless interface capable of connecting the handheld electronic apparatus 1 with the computer 17.

When the handheld electronic apparatus 1 is moved from a first position to a second position (e.g., a user moves the handheld electronic apparatus 1 from the first position to the second position), the sensor 11 generates a plurality of sensed data 106. The processing unit 13 firstly calculates a movement direction and a movement distance according to the sensed data 106. Then, the processing unit 13 generates a control signal 102 carrying the movement direction and the movement distance. The interface 15 transmits the control signal 102 to the computer 17.

Upon receiving the control signal 102, the computer 17 controls a cursor shown on a monitor of the computer 17 to move from a first coordinate on the monitor to a second coordinate on the monitor according to the movement direction and a movement distance carried in the control signal 102. It shall be appreciated that the corresponding relationships between the distance from the first coordinate to the second coordinate and the movement distance carried in the control signal 102 may be set as needed by the user through the computer 17.

As can be known from the above description, with the arrangement of the first embodiment, the user can easily control the cursor shown on the monitor of the computer 17 by moving the handheld electronic apparatus 1.

In a second embodiment of the present invention, the sensor 11 is defined as an optical lens. Therefore, the second embodiment differs from the first embodiment only in operations related to the sensor 11 and the method in processing/using the sensed data 106. Hereinbelow, only the differences between the two embodiments will be detailed, and the other operations in the second embodiment identical to those in the first embodiment will not be further described herein.

Because the sensor 11 is an optical lens, the user operates the handheld electronic apparatus 1 on a working surface (not shown). For example, the working surface may be a finger surface or some other surface with textures. When the user uses the handheld electronic apparatus 1 as a control apparatus (e.g., a mouse) of the computer 17, the user moves the handheld electronic apparatus 1 from the first position on the working surface to the second position on the working surface. It shall be appreciated that the user may also change to move the working surface (e.g., move a finger in front of the optical lens) instead, and this operation mode may also be understood as moving the handheld electronic apparatus 1 from the first position on the working surface to the second position on the working surface.

In the moving process, the sensor 11 obtains a plurality of sensed data 106 by capturing a plurality of images from the working surface; that is, each of the sensed data 106 is a captured image. Then, the processing unit 13 calculates the movement direction and the movement distance of the handheld electronic apparatus 1 by comparing the captured images. It shall be appreciated that the method in which the processing unit 13 determines the movement direction and the movement distance according to the plurality of captured images is well known to those of ordinary skill in the art, and thus, will not be further described herein.

In other implementations, the handheld electronic apparatus 1 may further comprise a light source unit (not shown). When the sensor 11 captures the images from the working surface, the light source unit generates a beam of light so that brighter captured images can be obtained as the sensed data 106. Furthermore, in other implementations, the handheld electronic apparatus 1 may further comprise a focal lens (not shown). The focal lens may be disposed in front of the optical lens so that images formed by the optical lens fall within a preferred depth-of-field range of the optical lens. Thus, the captured images obtained by the sensor 11 become relatively clear, and the movement direction and the movement distance calculated by the processing unit 13 become more accurate correspondingly.

In a third embodiment of the present invention, the sensor 11 is defined as a G-sensor. Therefore, the third embodiment differs from the first embodiment only in operations related to the sensor 11 and the method in which the sensed data 106 is processed/used. Hereinbelow, only differences between the two embodiments will be detailed, and the other operations in the third embodiment identical to those in the first embodiment will not be further described herein.

The sensor 11 is a G-sensor. Therefore, when the handheld electronic apparatus 1 is moved from the first position to the second position, the sensor 11 outputs a plurality of output signals according to a report rate thereof, and each of the output signals carries at least one acceleration datum (e.g., an acceleration datum in an X-axis direction, an acceleration datum in a Y-axis direction and/or an acceleration datum in a Z-axis direction).

Furthermore, if the user uses a large force to move the handheld electronic apparatus 1, the output signals of the G-sensor will carry large-acceleration data because the moving speed is relatively fast. Conversely, if the user uses a small force to move the handheld electronic apparatus 1, the output signals of the G-sensor will carry small-acceleration data because the moving speed is relatively slow.

Then, the processing unit 13 calculates the movement direction and the movement distance of the handheld electronic apparatus 1 by comparing the output signals of the G-sensor. For example, the processing unit 13 may view that the acceleration data carried in the output signals is in direct proportion to the movement distance, so when the acceleration data is larger, the movement distance calculated by the processing unit 13 will be larger.

Subsequently, upon receiving the control signal 102, the computer 17 controls a cursor shown on a monitor of the computer 17 to move from a first coordinate to a second coordinate according to the movement direction and the movement distance carried in the control signal 102.

FIG. 1 refers a fourth embodiment of the present invention. The main difference between the fourth embodiment and the first embodiment is that the processing unit 13 further provides a processing procedure that is executed after the handheld electronic apparatus 1 stops at the second position. Hereinbelow, only differences between the two embodiments will be detailed. The other operations in the fourth embodiment identical to those in the first embodiment will not be further described herein.

Specifically, the processing unit 13 determines that the handheld electronic apparatus 1 stops at the second position according to the sensed data 106 generated by the sensor 11. Then, the interface 15 transmits another control signal 104 to the computer 17 according to a determination result of the processing unit 13 so that the computer 17 controls the cursor to move from the second coordinate on the monitor to a third coordinate on the monitor according to the control signal 104.

For example, the handheld electronic apparatus 1 may set the content of the control signal 104 according to the user's habits of operating the computer mouse. According to the user's habits of operating the computer mouse, an increase in the deceleration of the computer mouse means that the user will very likely perform the next movement to rapidly move the cursor shown on the monitor closer to the directed target. Conversely, a decrease in the deceleration of the computer mouse shows that the cursor on the monitor is close to the target. In consideration of the aforesaid user's habits of operating the computer mouse, the processing unit 13 can calculate the deceleration of the handheld electronic apparatus 1 according to the sensed data 106 and then determine a value of the deceleration of the handheld electronic apparatus 1. When the deceleration of the handheld electronic apparatus 1 is relatively large (e.g., larger than a first threshold), the control signal 104 transmitted by the interface 15 carries a relatively large movement distance value so that the computer 17, according to the control signal 104, controls the cursor to move from the second coordinate on the monitor to the third coordinate that is relatively far from the second coordinate (i.e., a distance from the second coordinate to the third coordinate is larger than a second threshold).

Conversely, when the deceleration of the handheld electronic apparatus 1 is relatively small (e.g., smaller than the first threshold), the control signal 104 transmitted by the interface 15 carries a relatively small movement distance value so that the computer 17, according to the control signal 104, controls the cursor to move from the second coordinate on the monitor to the third coordinate that is relatively close to the second coordinate (i.e., a distance from the second coordinate to the third coordinate is smaller than the second threshold).

As can be known from the above description, the fourth embodiment takes the user's habits of operating the mouse into consideration, so a more accurate control effect can be achieved when the user controls the cursor shown on the monitor of the computer 17 by moving the handheld electronic apparatus 1.

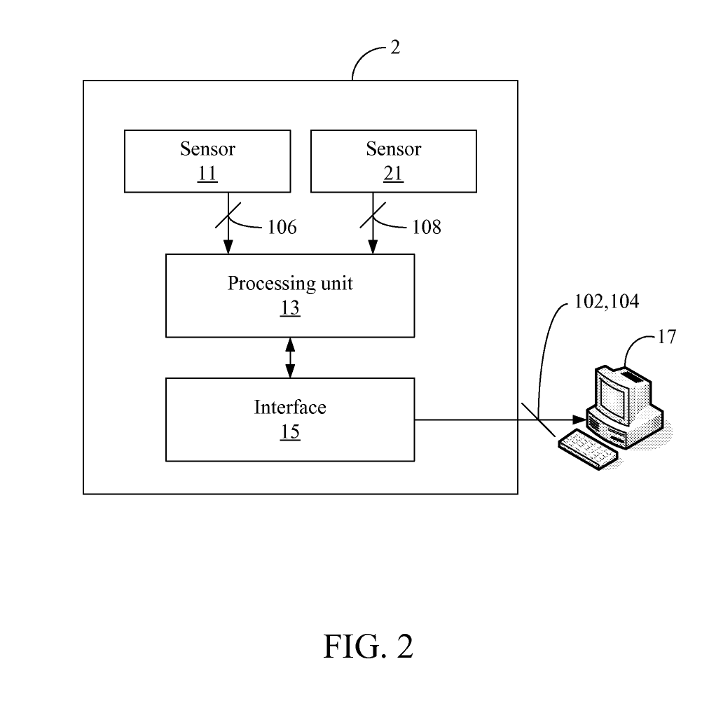

A fifth embodiment of the present invention is a handheld electronic apparatus 2, a schematic view of which is shown in FIG. 2. The handheld electronic apparatus 2 comprises sensors 11, 21, a processing unit 13 and an interface 15. The processing unit 13 is electrically connected to the sensors 11, 21 and the interface 15. Furthermore, the handheld electronic apparatus 2 is connected to a computer 17 via the interface 15. The handheld electronic apparatus 2 of the fifth embodiment is similar to the handheld electronic apparatus 1 of the first embodiment, so the following description will only focus on differences therebetween.

In the fifth embodiment, the handheld electronic apparatus 2 is additionally provided with the sensor 21 as compared to the handheld electronic apparatus 1. Therefore, when the handheld electronic apparatus 2 is moved from the first position to the second position, both the sensors 11, 21 will operate. The processing unit 13 will perform subsequent processing operations according to the operations of the sensors 11, 21.

Specifically, when the handheld electronic apparatus 2 is moved from the first position to the second position, the sensor 11 generates sensed data 106, and the processing unit 13 calculates a first direction and a first distance according to the sensed data 106 in the same manner as that described in the first to the third embodiments. Similarly, the sensor 21 also generates a plurality of sensed data 108, and the processing unit 13 also calculates a second direction and a second distance according to the sensed data 108 in the same manner as that has been described in the first to third embodiments.

Then, the processing unit 13 determines the movement direction according to the first direction and the second direction, and determines the movement distance according to the first distance and the second distance. As an example, the user may set the sensors 11, 21 of the handheld electronic apparatus 2 as a primary sensor and a secondary sensor respectively. In this case, if the sensor 11 generates the sensed data 106 but the sensor 21 does not generate the sensed data 108, then the processing unit 13 will perform subsequent processing operations according to the sensed data 106 because the primary sensor operates normally. In other words, the processing unit 13 determines that the movement direction is the first direction and the movement distance is the first distance. If the sensor 11 does not generate the sensed data 106, but the sensor 21 generates the sensed data 108, then both the movement direction and the movement distance determined by the processing unit 13 will be 0 (i.e., the cursor shown on the monitor of the computer 17 will not be moved) because the sensor 21 is not the primary sensor.

As another example, the user may not distinguish the sensors 11, 21 as a primary sensor or a secondary sensor. In this case, if the processing unit 13 determines that the sensed data 106, 108 lead to inconsistent results (e.g., the first direction and the second direction are opposite), then both the movement direction and the movement distance determined by the processing unit 13 will also be 0. If the processing unit 13 determines that the sensed data 106, 108 do not lead to inconsistent results, then the processing unit 13 may determine that the movement direction is an average value of the first direction and the second direction and the movement distance is an average value of the first distance and the second distance.

As can be known from the above description, the fifth embodiment uses various sensors in the handheld electronic apparatus 2 so a more accurate control effect can be achieved when the user controls the cursor shown on the monitor of the computer 17 by moving the handheld electronic apparatus 2. Furthermore, the user can also choose how to use the sensors (e.g., using only one of the sensors, or defining one of the sensors as a primary sensor with the rest of the sensors being secondary sensors), and this can add to convenience in use.

The handheld electronic apparatuses 1, 2 described in the first to the fifth embodiments each further comprise an input unit (not shown), which may be a touch screen, a button, and/or some other unit with the inputting function. The input unit generates an input signal (not shown) when being triggered, and the interface 15 transmits the input signal to the computer 17 so that the computer 17 selects a content corresponding to the cursor shown on the monitor according to the input signal. Through the arrangement of the input unit, the handheld electronic apparatuses 1, 2 can provide more complete functions for the user.

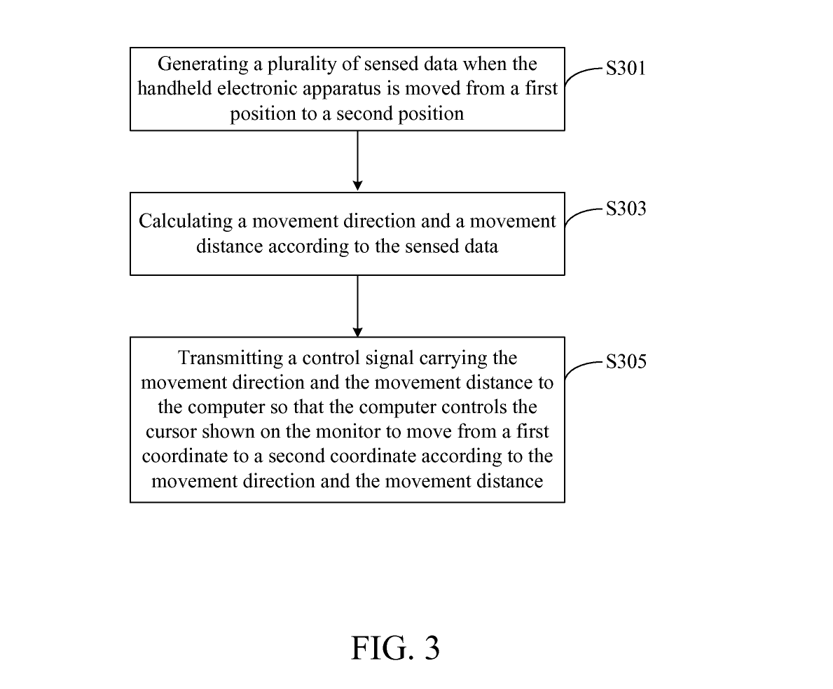

A sixth embodiment of the present invention is an operating method of a handheld electronic apparatus, a flowchart diagram of which is shown in FIG. 3. The operating method is suitable for use in a handheld electronic apparatus (refer to the handheld electronic apparatus 1 and the handheld electronic apparatus 2 described above), and is used to control a cursor shown on a monitor of a computer.

First, step S301 is executed to generate a plurality of first sensed data when the handheld electronic apparatus is moved from a first position to a second position. As an example, if the handheld electronic apparatus comprises an optical lens, then the first position and the second position are on a working surface and step S301 is executed to generate the first sensed data by the optical lens by capturing a plurality of images from the working surface. In this case, if the handheld electronic apparatus further comprises a light source unit, then the operating method may further execute a step to generate a beam of light when the optical lens captures the images from the working surface in the step S301. As another example, if the handheld electronic apparatus comprises a G-sensor, then step S301 will be executed by the G-sensor. Each of the sensed data is an output signal of the G-sensor, and each of the output signals carries at least one acceleration datum.

Then, step S303 is executed to enable the handheld electronic apparatus to calculate a movement direction and a movement distance according to the sensed data generated in the step S301. Thereafter, step S305 is executed to enable the handheld electronic apparatus to transmit a control signal carrying the movement direction and the movement distance to the computer so that the computer controls the cursor shown on the monitor to move from a first coordinate to a second coordinate according to the movement direction and movement distance.

In other implementations, the operating method may provide other steps according to the user's habits of operating the computer mouse to control the cursor shown on the monitor more accurately. Specifically, the operating method may further execute a step to determine that the handheld electronic apparatus stops at the second position according to the sensed data. Then, the operating method further executes another step to transmit another control signal to the computer so that the computer controls the cursor shown on the monitor to move from the second coordinate to a third coordinate according to the control signal.

In other implementations, the operating method further executes a step to generate an input signal when an input unit of the handheld electronic apparatus is triggered. Thereafter, the operating method further executes another step to transmit the input signal to the computer so that the computer selects a content corresponding to the cursor shown on the monitor according to the input signal.

In other implementations where the handheld electronic apparatus comprises a plurality of sensors, the operating method may execute the steps S301 and S303 repeatedly, and then determine the movement direction and a movement distance, which are to be finally transmitted to the computer 17, according to a plurality of movement directions and a plurality of movement distances obtained in the step S303.

In addition to the aforesaid steps, the operating method of a handheld electronic apparatus of the sixth embodiment can also execute all the operations and functions set forth in the first to a fifth embodiments. The method in which the sixth embodiment executes these operations and functions can be readily appreciated by those of ordinary skill in the art based on the explanation of the first to fifth embodiments, and thus, will not be further described herein.

Furthermore, the operating method described in the sixth embodiment may be implemented by a non-transitory computer readable medium. When the non-transitory computer readable medium is loaded into a handheld electronic apparatus and a plurality of codes comprised therein is executed, the operating method described in the sixth embodiment can be accomplished. The aforesaid non-transitory computer readable medium may be a file capable of being transmitted in a network, and may also be stored in a computer readable medium such as a read only memory (ROM), a flash memory, a floppy disk, a hard disk, a compact disk, a mobile disk, a magnetic tape, a database accessible to networks, or any other storage media with the same function that is well known to those skilled in the art.

As can be known from the descriptions of the aforesaid embodiments, the present invention determines a movement direction and a movement distance according to the sensed data generated by the sensor(s) of the handheld electronic apparatus so that the computer can control a position of the cursor shown on the monitor according to the movement direction and a movement distance. Through the present invention, the user can easily operate the cursor shown on the monitor of the computer by means of the portable handheld electronic apparatus.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A handheld electronic apparatus, comprising:
a first sensor, being configured to generate a plurality of first sensed data while the handheld electronic apparatus is moved from a first position to a second position;
a processing unit, being configured to calculate a movement direction and a movement distance according to the first sensed data; and
an interface, being adapted to be connected to a computer having a monitor and configured to transmit a first control signal carrying the movement direction and the movement distance to the computer so that the computer controls a cursor shown on the monitor to move from a first coordinate to a second coordinate according to the movement direction and the movement distance.

2. The handheld electronic apparatus of claim 1, further comprising:
a second sensor, being configured to generate a plurality of second sensed data while the handheld electronic apparatus is moved from the first position to the second position;
wherein the processing unit calculates a first direction and a first distance according to the first sensed data, calculates a second direction and a second distance according to the second sensed data, determines the movement direction according to the first direction and the second direction, and determines the movement distance according to the first distance and the second distance.

3. The handheld electronic apparatus of claim 1, wherein the first sensor is an optical lens, the first position and the second position are on a working surface, and the first sensor generates the first sensed data by capturing a plurality of images from the working surface.

4. The handheld electronic apparatus of claim 3, further comprising:
a light source unit, being configured to generate a beam of light while the first sensor captures the images from the working surface.

5. The handheld electronic apparatus of claim 1, wherein the first sensor is a G-sensor, each of the first sensed data is an output signal of the G-sensor, and each of the output signals carries at least one acceleration datum.

6. The handheld electronic apparatus of claim 1, wherein the processing unit further determines that the handheld electronic apparatus stops at the second position according to the first sensed data and the interface further transmits a second control signal to the computer according to a determination result of the processing unit so that the computer controls the cursor to move from the second coordinate to a third coordinate according to the second control signal.

7. The handheld electronic apparatus of claim 1, further comprising:
an input unit, being configured to generate an input signal while the input unit is triggered;
wherein the interface further transmits the input signal to the computer so that the computer selects a content corresponding to the cursor shown on the monitor according to the input signal.

8. The handheld electronic apparatus of claim 7, wherein the input unit is one of a touch screen, a button, and a combination thereof.

9. An operating method of a handheld electronic apparatus for controlling a cursor shown on a monitor, the monitor being comprised in a computer, and the operating method comprising the following steps of:
(a) generating a plurality of first sensed data while the handheld electronic apparatus is moved from a first position to a second position;
(b) calculating a movement direction and a movement distance according to the first sensed data; and
(c) transmitting a first control signal carrying the movement direction and the movement distance to the computer so that the computer controls the cursor shown on the monitor to move from a first coordinate to a second coordinate according to the movement direction and the movement distance.

10. The operating method of claim 9, further comprising the following steps of:
(d) generating a plurality of second sensed data while the handheld electronic apparatus is moved from the first position to the second position;
(e) calculating a first direction and a first distance according to the first sensed data; and
(f) calculating a second direction and a second distance according to the second sensed data;
wherein the step (b) determines the movement direction according to the first direction and the second direction and determines the movement distance according to the first distance and the second distance.

11. The operating method of claim 9, wherein the first sensed data of the step (a) is generated by an optical lens of the handheld electronic apparatus, the first position and the second position are on a working surface, and the step (a) generates the first sensed data by the optical lens through capturing a plurality of images from the working surface.

12. The operating method of claim 11, further comprising the following step of:
generating a beam of light by a light source unit of the handheld electronic apparatus while the optical lens captures the images from the working surface.

13. The operating method of claim 9, wherein the first sensed data of the step (a) is generated by a G-sensor of the handheld electronic apparatus, each of the first sensed data is an output signal of the G-sensor, and each of the output signals carries at least one acceleration datum.

14. The operating method of claim 9, further comprising the following steps of:
determining that the handheld electronic apparatus stops at the second position according to the first sensed data; and
transmitting a second control signal to the computer so that the computer controls the cursor to move from the second coordinate to a third coordinate according to the second control signal.

15. The operating method of claim 9, further comprising the following steps of:
generating an input signal while an input unit of the handheld electronic apparatus is triggered; and
transmitting the input signal to the computer so that the computer selects a content corresponding to the cursor shown on the monitor according to the input signal.

16. A non-transitory computer readable medium, having a computer program stored therein, the computer program executing an operating method after being loaded into a handheld electronic apparatus so that the handheld electronic apparatus controls a cursor shown on a monitor, the monitor being comprised in a computer, and the computer program comprising:
a code A for generating, by the handheld electronic apparatus, a plurality of first sensed data while the handheld electronic apparatus is moved from a first position to a second position;
a code B for calculating, by the handheld electronic apparatus, a movement direction and a movement distance according to the first sensed data; and
a code C for transmitting, by the handheld electronic apparatus, a first control signal carrying the movement direction and the movement distance to the computer so that the computer controls the cursor shown on the monitor to move from a first coordinate to a second coordinate according to the movement direction and the movement distance.

17. The non-transitory computer readable medium of claim 16, wherein the computer program further comprises:
a code D for generating, by the handheld electronic apparatus, a plurality of second sensed data while the handheld electronic apparatus is moved from the first position to the second position;
a code E for calculating, by the handheld electronic apparatus, a first direction and a first distance according to the first sensed data; and
a code F for calculating, by the handheld electronic apparatus, a second direction and a second distance according to the second sensed data;
wherein the code B determines the movement direction according to the first direction and the second direction and determines the movement distance according to the first distance and the second distance.
